(19) United States
(12) Patent Application Publication
(10) Pub. No.: US 2018/0320640 A1
(43) Pub. Date: Nov. 8, 2018

(54) LONG-ROUTE EGR SYSTEM

(71) Applicant: GM GLOBAL TECHNOLOGY OPERATIONS LLC, Detroit, MI (US)

(72) Inventor: Alberto RACCA, Cavallermaggiore (CN) (IT)

(73) Assignee: GM GLOBAL TECHNOLOGY OPERATIONS LLC, Detroit, MI (US)

(21) Appl. No.: 15/589,177

(22) Filed: May 8, 2017

(51) Int. Cl. F02M 26/06; F02M 26/22; F02M 26/48; F02M 26/65; F01N 3/00

(52) U.S. Cl. CPC F02M 26/06; F02M 26/22; F01N 3/00; F02M 26/65; F02M 26/48

(57) ABSTRACT

Exhaust gas recirculation systems are provided for an internal combustion engine. The system includes an exhaust conduit configured to receive exhaust gas from the internal combustion engine. A junction is disposed to receive the exhaust gas from the exhaust conduit. An EGR conduit is connected with the junction and configured to recirculate a portion of the exhaust gas to the internal combustion engine. A tailpipe is connected with the junction and configured to discharge at least a portion of the exhaust gas to atmosphere. A control valve is disposed at the junction and is configured to control entry of the exhaust gas into the EGR conduit, and the control valve is configured to throttle entry of the exhaust gas into the tailpipe.

### TECHNICAL FIELD

The present disclosure generally relates to an internal combustion engine, typically an internal combustion engine of a motor vehicle and more particularly relates to exhaust gas recirculation systems for internal combustion engines.

### BACKGROUND

Internal combustion engines such as those used in automobiles may process a working fluid containing combustion air and fuel within one or more combustion chambers. Processing of the working fluid within a combustion chamber produces exhaust gas. Some automotive systems may include an exhaust gas recirculation (EGR) system configured for recirculating a portion of the exhaust gas back into the internal combustion engine within the combustion air, thereby providing desirable combustion characteristics. For example, the addition of EGR results in a lower combustion temperature. Some internal combustion engines may also include a charging system with a compressor configured to increase the pressure of the combustion air delivered to the engine for the combustion process. These compressors may operate at high rotational speeds and may be exposed to a mixture of exhaust gas and ambient intake air when certain forms of EGR are employed.

Accordingly, it is desirable to provide EGR systems that effectively control the flow of gases through the various components. Furthermore, other desirable features and characteristics of the present invention will become apparent from the subsequent detailed description and the appended claims, taken in conjunction with the accompanying drawings and the foregoing technical field and background.

### SUMMARY

In a number of embodiments, an exhaust gas recirculation system is provided for an internal combustion engine. The system includes an exhaust conduit configured to receive exhaust gas from the internal combustion engine. A junction is disposed to receive the exhaust gas from the exhaust conduit. An EGR conduit is connected with the junction and is configured to recirculate a portion of the exhaust gas to the internal combustion engine. A tailpipe is also connected with the junction and is configured to discharge at least a portion of the exhaust gas to atmosphere. A control valve is disposed at the junction and is configured to control entry of the exhaust gas into the EGR conduit and into the tailpipe.

In a number of additional embodiments, an exhaust gas recirculation system is provided for an internal combustion engine. The exhaust gas recirculation system includes an exhaust conduit configured to receive exhaust gas from the internal combustion engine. An exhaust aftertreatment system is disposed in the exhaust conduit. A junction is disposed to receive the exhaust gas from the exhaust conduit and is located downstream of at least a portion of the aftertreatment system from the internal combustion engine. An EGR conduit is connected with the junction and is configured to recirculate a portion of the exhaust gas to the internal combustion engine. A tailpipe is connected with the junction and is configured to discharge at least a portion of the exhaust gas to atmosphere. A control valve is disposed at the junction with a valve plate in the control valve configured to control entry of the exhaust gas into the EGR conduit. The valve plate is also configured to throttle entry of the exhaust gas into the tailpipe.

In other embodiments, an exhaust gas recirculation system is provided for an internal combustion engine. A turbine is configured to receive exhaust gas from the internal combustion engine. A compressor is connected with the turbine and is configured to charge combustion air supplied to the internal combustion engine. The compressor has an inlet end configured to receive the combustion air. An intake duct is connected with the compressor and is configured to supply the combustion air to the inlet end. An exhaust conduit is configured to receive the exhaust gas from the turbine. A junction is disposed to receive the exhaust gas from the exhaust conduit. An EGR conduit is connected with the junction and is configured to recirculate a portion of the exhaust gas to the internal combustion engine through the compressor. A tailpipe is connected with the junction and is configured to discharge at least a portion of the exhaust gas to atmosphere. A control valve is disposed at the junction and has a valve plate configured to control entry of the exhaust gas into the EGR conduit. The valve plate is also configured to throttle entry of the exhaust gas into the tailpipe.

### DESCRIPTION OF THE DRAWINGS

The exemplary embodiments will hereinafter be described in conjunction with the following drawing figures, wherein like numerals denote like elements.

FIG. 1 is a schematic view of an automotive system according to an exemplary embodiment;

FIG. 2 is the section A-A of an internal combustion engine belonging to the automotive system of FIG. 1;

FIG. 3 is a schematic illustration of a part of the automotive system of FIG. 1 in accordance with an exemplary embodiment;

FIG. 4 is a schematic illustration of a part of the automotive system of FIG. 1 in accordance with an exemplary embodiment;

FIG. 5 is schematic illustration of a part of the automotive system of FIG. 1 in accordance with an exemplary embodiment; and

FIG. 6 is a schematic illustration of a part of the automotive system of FIG. 1, in accordance with an exemplary embodiment.

### DETAILED DESCRIPTION

The following detailed description is merely exemplary in nature and is not intended to limit the invention disclosed herein or the application and uses of the invention disclosed herein. Furthermore, there is no intention to be bound by any principle or theory, whether expressed or implied, presented in the preceding technical field, background, summary or the following detailed description, unless explicitly recited as claimed subject matter.

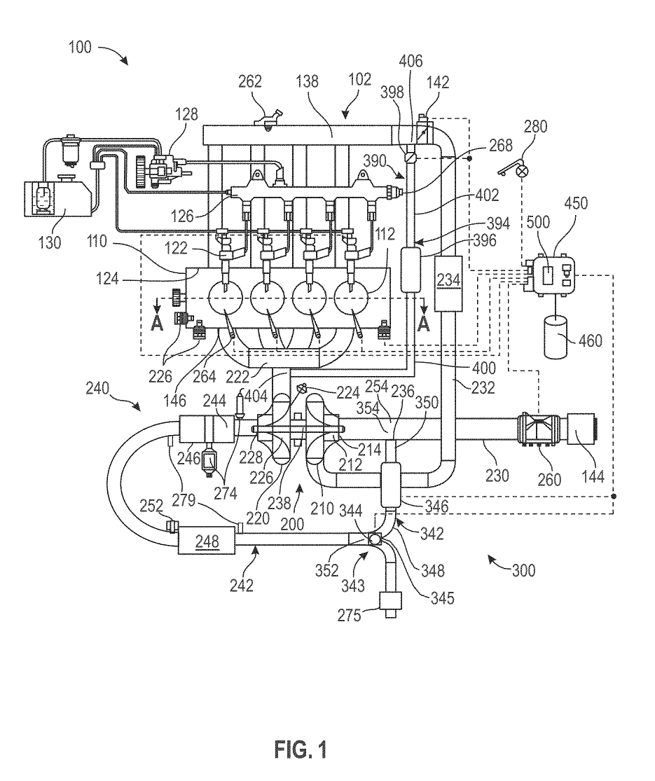

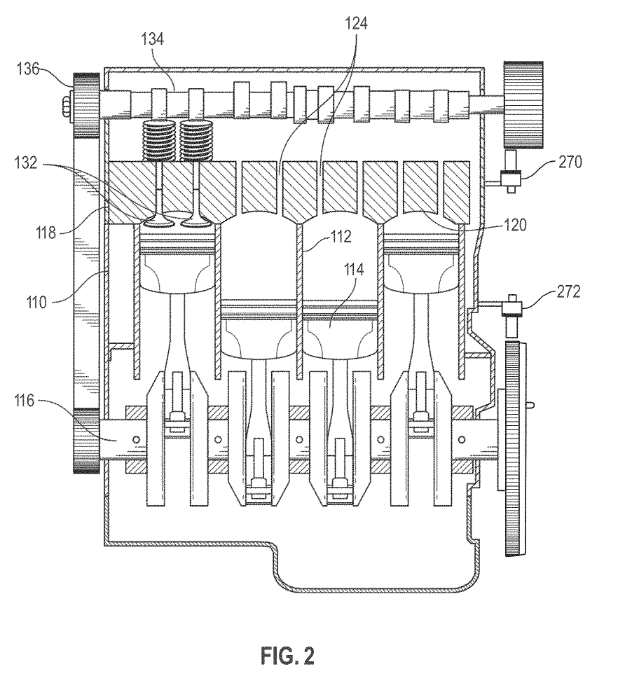

Some embodiments may include an automotive system 100 as shown in FIGS. 1 and 2, which includes an internal combustion engine 102. It is appreciated that the engine 102 and various aspects of the overall system 100 are merely exemplary in nature and that embodiments described herein may be implemented in various engine systems.

In the illustrated embodiment, the engine 102 includes an engine block 110 defining at least one cylinder 112 having a piston 114 coupled to rotate a crankshaft 116. A cylinder head 118 cooperates with the piston 114 and the block 110 to define a combustion chamber 120. A fuel and combustion air mixture (not shown) enters the combustion chamber 120 and is ignited, thereby resulting in hot expanding exhaust gas forcing reciprocal movement of the piston 114. The combustion air is provided through at least one intake port 124, and the fuel is provided via at least one fuel injector 122. The fuel may be delivered from a fuel rail 126 in fluid communication with a high pressure fuel pump 128 and a fuel source 130. Each of the cylinders 112 has at least two valves 132, which may be actuated by a camshaft 134 rotating in time with the crankshaft 116. At least one of the valves 132 selectively allows combustion air into the combustion chamber 120 from the port 124. The other valve 132, or a different set of valves (not shown), selectively allows post combustion gases to exit the combustion chamber 120 as exhaust gas. In some examples, a cam phaser 136 may selectively vary the timing between the camshaft 134 and the crankshaft 116.

The combustion air may be distributed to multiple air intake ports 124 through an intake manifold 138. An air intake duct 230 may provide a route for the supply of ambient intake air from the external environment for downstream delivery to the intake manifold 138. In one embodiment, the air intake duct 230 may include a filter 144 for filtering incoming air, and further, a temperature sensor 260 may be provided to provide information on the temperature of the incoming intake air. After combustion, the exhaust gas flows out of the cylinder 112 through exhaust ports 146 to an exhaust manifold 222.

A turbocharger 200 or other type of forced air system may be provided to increase the amount of air mass that flows into the combustion chamber 120. The turbocharger 200 may include a compressor 210 rotationally coupled to a turbine 220. A turbine wheel 226 of the turbine 220 is adapted for flow-through passage of exhaust gases from the engine 102. The turbine 220 is fluidly coupled to the exhaust manifold 222 of the engine 102 and rotates by receiving exhaust gas from the exhaust manifold 222. The example of FIG. 1 depicts a variable geometry turbine (VGT) with a VGT actuator 224 arranged to move vanes of the turbine 220 to alter the flow of the exhaust gas over the turbine wheel 226. In other embodiments, the turbocharger 200 may have a fixed vane geometry and/or may include a waste gate through which exhaust gas may selectively bypass the turbine wheel 226.

Exhaust gas flowing through the turbine 220 exits at turbine outlet 228. The exhaust gases drive the turbine wheel 226 to rotate for correspondingly rotating a turbocharger shaft 238 and a connected compressor wheel 212 of the compressor 210. The compressor wheel 212 may comprise a centrifugal impeller the type having a central hub extending along its rotational axis from a relatively small diameter nose disposed at an inlet end 214 of the compressor 210 to a significantly larger wheel or tip diameter at an opposite end. The compressor wheel 212 may be formed from a relatively lightweight, relatively low inertia material such as an aluminum alloy. Intake air may flow from the intake duct 230 into the compressor 210 at its inlet end 214. The compressor 210 increases the pressure and temperature of the incoming air and subsequently directs charge air away from the compressor wheel 212 and through a turbocharger outlet duct 232 to the intake manifold 138. A charge air cooler 234 may be disposed in the turbocharger outlet duct 232 to reduce the temperature of the charge air prior to entering the intake manifold 138.

In the illustrated embodiment, exhaust gas exiting the turbine 220 is directed through an exhaust conduit 242. In general, the exhaust conduit 242 extends from the turbine outlet 228 downstream to a junction 343. The exhaust conduit 242 has one or more exhaust aftertreatment devices configured to change the composition of the exhaust gas. Some examples of aftertreatment devices of the aftertreatment system 240 include, but are not limited to, catalytic converters (two and three way), oxidation catalysts, lean NOx traps, hydrocarbon adsorbers, selective catalytic reduction (SCR) systems, and particulate filters, such as a Selective Catalytic Reduction on Filter (SCRF). By way of example, the after-treatment devices of the aftertreatment system 240 may include a diesel oxidation catalyst (DOC) 244 for degrading residual hydrocarbons (HC) and carbon oxides (CO) contained in the exhaust gas, and a diesel particulate filter (DPF) 246 for capturing and removing diesel particulate matter from the exhaust gas. The aftertreatment devices of the aftertreatment system 240 may further include selective catalytic reduction (SCR) system components, such as a SCR catalyst 248 disposed in the exhaust conduit 242 downstream of the DPF 246, and a diesel-exhaust-fluid (DEF) injector 252 disposed in the exhaust conduit 242 between the DPF 246 and the SCR catalyst 248.

One or more EGR systems 300, 390 are provided to recirculate exhaust gas to the cylinders 112 of the engine 120. The exhaust gas is inert to combustion and displaces otherwise combustible oxygen. With added EGR in the combustion air mixture, reduced combustion temperatures and reduced NOx formation results from the combustion process of the automotive system 100. Generally, the EGR systems 300, 390 include a “long-route” (LR-EGR) system 300 and a “short-route” (SR-EGR) system 390, although both systems 300 and 390 may not be included in some embodiments.

In some embodiments, the SR-EGR system 390 includes a high pressure loop, cooled EGR configuration. In general, the SR-EGR system 390 includes a conduit 394 configured to controllably, fluidly couple the exhaust manifold 222 with the intake manifold 138. The conduit 394 extends through an EGR cooler 396, and a SR-EGR valve 398. The conduit 394 may be defined by a number of elements including a pre-cooler pipe 400, the EGR cooler 396, and a post-cooler pipe 402 that contains the SR-EGR valve 398. Some embodiments may include a cooler bypass with a control valve providing an alternate flow path around the EGR cooler 396, when reduced cooling is prescribed. The conduit 394 may include other elements and may be configured in other variations or with other coupling positions to deliver exhaust gas from the exhaust manifold 222 to the intake manifold 138. Various additional valves, sensors, and the like may be provided for operating the SR-EGR system 390, including control of the SR-EGR valve 398.

When a demand for SR-EGR gas exists, the SR-EGR valve 398 is opened and a portion of the exhaust gas available at the exhaust manifold 222 is channeled through the pre-cooler pipe 400 and proceeds to the EGR cooler 396. SR-EGR gas then flows through the post-cooler pipe 402 and through the SR-EGR valve 398. The SR-EGR gas is delivered to the intake manifold 138 where it mixes with charge air delivered from the compressor 210. The mixture of intake air and SR-EGR gas as combustion air is then inducted into the engine 102 through the intake manifold 138. Exhaust gas enters the conduit 394 from a high-pressure point 404 at the exhaust manifold 222, which receives exhaust gas pumped by the pistons 114. Through the conduit 394, exhaust gas is supplied to another high-pressure point 406 at the intake manifold 138, which is charged by the compressor 210. The pressure differential between these two points 404, 406 may be insufficient to drive the EGR flow rate prescribed for all engine operating conditions. Accordingly, alternative mechanisms may be used to increase the pressure differential between points 404 and 406. These alternative mechanisms may include an additional EGR pump, or use of the VGT aspect of the turbine 220 to reduce the pressure output of the compressor 210.

In the current embodiment, the LR-EGR system 300 is configured to deliver LR-EGR gas to the engine 102, including high EGR flow rates when prescribed. In general, the LR-EGR system 300 includes a low-pressure loop, cooled EGR configuration. The LR-EGR system 300 includes an EGR conduit 342 configured to fluidly couple the exhaust conduit 242 with the intake duct 230. A control valve 344 and an EGR cooler 346 are disposed in the EGR conduit 342. The EGR conduit 342 may be defined by a number of elements including a pre-cooler pipe 348, the EGR cooler 346, and a post-cooler pipe 350. The pre-cooler pipe 348 is fluidly coupled with the exhaust conduit 242 downstream of the turbine 220. More specifically, the LR-EGR pre-cooler conduit 302 branches from a portion of the exhaust conduit 242 at a junction 343 located downstream of the DPF 246 and the SCR catalyst 248. In some embodiments where the aftertreatment system 240 is configured differently, such as with underfloor bricks for the SCR catalyst 248 at a tailpipe 282, the junction 343 is located downstream of a portion of the aftertreatment system 240, and is located upstream of a portion of the aftertreatment system 240 (the underfloor bricks). The post-cooler pipe 350 is fluidly coupled with the intake duct 230 at the junction 236. This coupling directs exhaust gas from the LR-EGR system 300 into the compressor 210 of the turbocharger 200. In this example, the LR-EGR post-cooler pipe 350 is joined at a portion of the intake duct 230 located between the air filter 144 and the compressor 210. Various other coupling positions of the EGR conduit 342 may be provided to supply exhaust gas to the compressor 120 at its inlet end 214. Additional valves, sensors, and the like may be provided for operating the LR-EGR system 300.

The control valve 344 is positioned at the junction 343 between the exhaust conduit 242, the EGR conduit 342, and the tailpipe 282. The tailpipe 282 provides an exhaust gas route for discharge to atmosphere. The control valve 344 is associated with an actuator 345 and is configured to control the amount of exhaust gas delivered from the exhaust pipe 242 to the LR-EGR system 300 at the EGR conduit 342. When a demand for LR-EGR exists, the control valve 344 opens an entry to the EGR conduit 342. Exhaust gas available at the exhaust conduit 242 is channeled through the pre-cooler pipe 348 and proceeds as LR-EGR gas to the EGR cooler 346. EGR gas then flows through the post-cooler pipe 350. Downstream of the post-cooler pipe 350, mixed intake air and LR-EGR gas form combustion air that flows through a portion of the intake duct 230 and passes into compressor 210 where it is compressed. The charge/combustion air is supplied from the compressor 210 to the engine 102 through the outlet duct 232 and the intake manifold 138. Compression causes the combustion air to become heated. Accordingly, the compressed, heated combustion air may be cooled in the charge air cooler 234 before passing to intake manifold 138. Some embodiments may include a bypass (not shown) with a control valve to provide an alternate flow path around the EGR cooler 346 and/or around the charge air cooler 234, when reduced cooling is prescribed.

The LR-EGR system 300 recirculates a portion of the exhaust gas back into the turbocharger 200 and thus back into the engine 102. The balance of exhaust gas flowing through the exhaust conduit 242 is directed to a tailpipe 282 with a muffler 284. In the LR-EGR system 300, exhaust gas enters the EGR conduit 342 from a low-pressure point 352 of the exhaust conduit 242 downstream of the turbine 220, and proceeds to another low-pressure point 354 of the intake duct 230 upstream of the compressor 210. To increase the pressure differential, an intake valve may be located between the junction 236 and the filter 144 to regulate the flow of ambient intake air in the intake duct 230. For example, through intake throttling, a reduction in intake air inflow results in more exhaust gas flow into the LR-EGR system 300 from the exhaust conduit 242. It should be appreciated that the LR-EGR system 300 configuration avoids the need for intake throttling.

The automotive system 100 may further include an electronic control unit (ECU) 450 in communication with one or more sensors and/or devices associated with various automotive system components. In FIG. 1, dashed lines are used to indicate communication between the ECU 450 and the various sensors and devices, but some are omitted for clarity. Generally, the ECU 450 may receive inputs from various sensors configured to generate signals in proportion to various physical parameters associated with the engine 102 and its subsystems. The sensors include, but are not limited to, a mass airflow and temperature sensor 260, a manifold pressure and temperature sensor 262, a combustion pressure sensor 264, a fuel rail pressure sensor 268, a cam position sensor 270, a crank position/rotational speed sensor 272, exhaust pressure sensors 274, an exhaust temperature sensor 275, NOx sensors 279, and an accelerator pedal position sensor 280. Furthermore, the ECU 450 may generate output signals to various control devices that are arranged to control the operation of the engine 102, including, but not limited to, the fuel injectors 122, the throttle valve 142, the EGR valve 398, the VGT actuator 224, and the cam phaser 136. Additional output signals may be generated by the ECU 450, particularly additional output signals associated with the LR-EGR system 300, including for control of the control valve 344. In one embodiment, an EGR control unit 500 may be implemented by the ECU 450 to control operation of the SR-EGR system 390 and/or the LR-EGR system 300, as will be described in greater detail below. In this context, the ECU 450, and/or more specifically the EGR control unit 500, may generate output signals associated with the control valve 344 and the EGR valve 398.

Generally, the ECU 450 may include a digital processing unit in communication with a memory system, such as data source 460, and an interface bus. The processing unit is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the processing unit to carry out the steps of such methods and control the automotive system 100.

The program stored in the memory system may be transmitted from outside via a cable or in a wireless fashion. In some instances, the program may be embodied as a computer program product, which is also called computer readable medium or machine readable medium in the art, and which should be understood to be a computer program code residing on a carrier, said carrier being transitory or non-transitory in nature with the consequence that the computer program product can be regarded to be transitory or non-transitory in nature. An example of a transitory computer program product is a signal, e.g. an electromagnetic signal such as an optical signal, which is a transitory carrier for the computer program code. Carrying such computer program code can be achieved by modulating the signal by a conventional modulation technique such as QPSK for digital data, such that binary data representing said computer program code is impressed on the transitory electromagnetic signal. Such signals are e.g. made use of when transmitting computer program code in a wireless fashion via a Wi-Fi connection to a laptop. In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an ASIC, a CD or the like. The ECU 450 may be embodied in any suitable form to provide the electronic logic, e.g. an embedded controller, an onboard computer, or any processing module that might be deployed in the vehicle.

A number of characteristics associated with the LR-EGR system 300 are implemented in various embodiments to avoid constraints on considering condensation and its potential effects. The LR-EGR system 300 re-circulates exhaust gas with vapor content resulting from fuel combustion. In addition, a byproduct in the exhaust stream of the SCR catalyst 248 is water. Under certain operating conditions of the engine 102, the compressor 210 and the charge air cooler 234 may experience a high value of relative humidity. If water condensation were to occur, such as in the form of water droplets, erosion and/or corrosion may occur. When condensed water mixes with exhaust gases the formation of acids may occur, which amplifies the potential for corrosive and erosive effects. This is particularly the case for the compressor wheel 212 which includes a tip and blades that rotate at high speed. Accordingly, condensation and the potential for high-speed impingement of droplets against the compressor wheel 212 are preferably avoided.

In this regard, reference is made to FIG. 1, and in particular to the portion of the LR-EGR system 300 in the area of the junction 236. Junction 236 is the connection area between the post-cooler pipe 350 and the intake duct 230, upstream of the compressor 210. In a number of embodiments the junction 236 is free of constraints otherwise associated with an intake throttle valve and/or LR-EGR valve positioning near the inlet of the compressor 120. More specifically, the post-cooler conduit 250 includes an injection segment 254 through which exhaust gas is routed prior to entering the intake duct 230. The injection segment 254 is configured free of constraints related to the inclusion of valves, and their actuators. Therefore the junction provides an unobstructed flow path to reduce the risk of condensation. In addition, intake air generally flows through the intake duct 230 and toward the compressor 210 without throttling. Specifically, no valve is included in the intake duct 230 between the air filter 144 and the compressor 210. Exhaust gas from the post-cooler conduit 250 is entrained into the intake duct 230 with mixing between the EGR gas and intake air at the junction 236. The junction 236 and the inlet end 214 of the compressor 210 are free of obstructions such as an air valve or a mixing valve that may require a structure design to accommodate the valves. The degrees of freedom afforded without a need to design the junction 236 to accommodate valves, enables enhanced condensation protection.

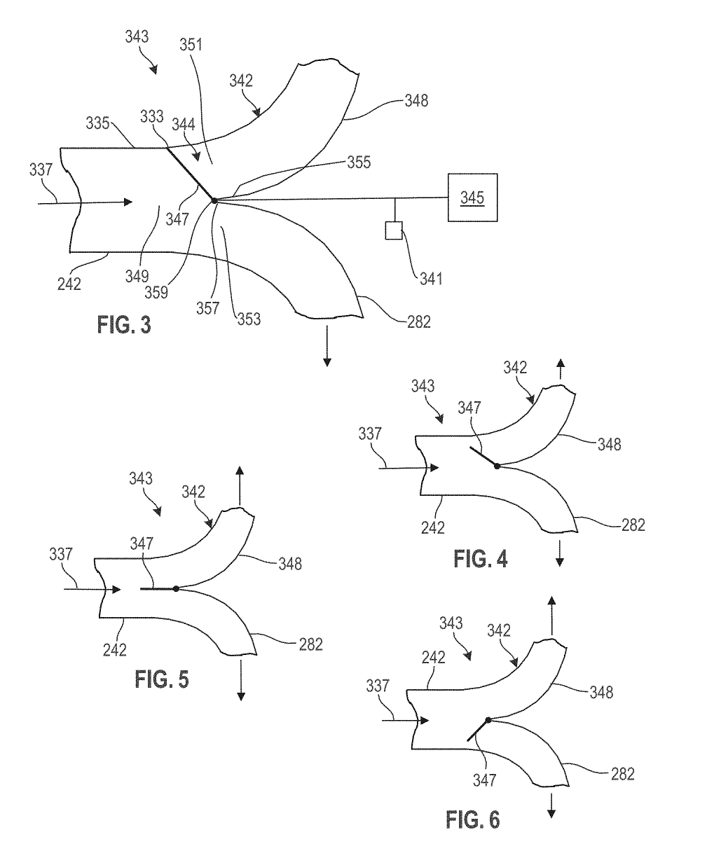

In a number of embodiments, avoidance of valving at the junction 236 is supported by details of the LR-EGR system 300 at the junction 343. FIG. 3 is a schematic depiction of a portion of the LR-EGR system 300 at the junction 343 between the exhaust conduit 242, the EGR conduit 342, and the tailpipe 282. Through the junction 343, incoming exhaust gas 337 from the engine 102 may be directed into the tailpipe 282 for exhaust to the atmosphere. In addition, incoming exhaust gas 337 may be directed through the junction 343 into the EGR conduit 342 for recirculation back to the engine 102. The control valve 344 controls exhaust gas flow through the junction 343. The control valve 344 is configured as a flap valve (as opposed to a butterfly or throttle valve) having a flap-type valve plate 347 operated by the actuator 345, which in this embodiment is an electric motor actuator. More particularly, the junction 343 forms a promontory 355 pointing into and bisecting the exhaust conduit 242 to divide the pre-cooler pipe 348 from the tailpipe 282. The promontory 355 terminates at a tip 357 that lies at an intersection of exhaust flow through the exhaust conduit 242, the pre-cooler pipe 348 and the tailpipe 282. A rotatable valve shaft 359 lies at the tip 357 with the valve plate 347 connected with the valve shaft 359 to rotate therewith. Through operation of the actuator 345, the valve shaft 359 is bi-directionally rotatable to move the valve plate 347 to variably open and close the outlet ports 351, 353 relative to the inlet port 349, as described in greater detail below.

The position of the valve plate 347 is monitored by a position sensor 341 configured to detect the location of the valve plate 347. The position sensor 341 supplies position information to the ECU 450. Accordingly, the control valve 344 is a motor actuated, variable position, feedback valve that controls exhaust gas flow between an inlet port 349 and two outlet ports 351 and 353.

As introduced above, an EGR control unit 500 may be implemented by the ECU 450 to control operation of the LR-EGR system 300 and the SR-EGR system 390. As such, the EGR control unit 500 may be considered part of the EGR systems 300, 390, particularly the LR-EGR system 300. The SR-EGR system 390 is in-general, controlled by the SR-EGR valve 398 and by the vane position of the turbine 220. For the LR-EGR system 300, a positive differential pressure between the exhaust conduit 242 and the inlet end 354 of the compressor 120 is needed to effect flow. The LR-EGR system 300 is, in general, controlled by the control valve 344.

With reference to FIGS. 1-6, the EGR control unit 500 controls various operational aspects of the EGR systems 300, 390. The EGR control unit 500 may implement one or more functional sub-units or modules for the SR-EGR system 390, and the LR-EGR system 300. Operation of the SR-EGR system 390 and the LR-EGR system 300 may be initiated individually or jointly, with control for conditions that call for EGR flow over the full operating map of the engine 102, particularly the situations described below. In one embodiment, the EGR control unit 500 may initiate operation based on input data such as that derived from signals supplied by the sensors 272, 280. In addition, the EGR control unit 500 may receive signals representing the NOx level in the exhaust gas, which may be supplied by the NOx sensor 279. In response, the EGR control unit 500 may compare the measured NOx level to a stored and/or calculated target NOx level for the given speed and load of the engine 102. When the measured NOx level exceeds the target NOx level, the EGR control unit 500 may initiate EGR flow through the SR-EGR system 390 and/or through the LR-EGR system 300. For example, control unit 500 commands the SR-EGR valve 398 to open.

With reference to FIG. 3, the port 351 is shown in a closed condition with exhaust gas routed through the port 353 to the tailpipe 282. The valve plate 347 is positioned so that its pivot at the shaft 359 is located at the tip 357 and its terminal edge 333 is positioned against the wall 335 of the exhaust conduit 242. In this position, the terminal edge 333 is located upstream (in relation to flow of the incoming exhaust gas 337), of the tip 357 in the exhaust conduit 242 so that the valve plate assists in directing exhaust gas flow toward the tailpipe 282. The resulting inclined nature of the valve plate 347 reduces backpressure creation in the exhaust conduit 242. FIG. 4 shows the valve plate 347 in an intermediate open state. The EGR control unit 500 continuously monitors inputs and sends commands to effect modulation of the valve plate 347 through operation of the actuator 345. In various embodiments the EGR controller 500 is supplied with data from the position sensor 341 representing the position of the valve plate 347. The valve plate 347 is variable through a range of open conditions of the LR-EGR system 300 between a closed position as shown in FIG. 3 and a fully open position as shown in FIG. 5.

When at the fully open position of FIG. 5, the valve plate 347 is positioned to minimize pressure loss both into the EGR conduit 342 and into the tailpipe 282. For example, the valve plate 347 is positioned in alignment with the incoming exhaust gas 337 of the exhaust conduit 242 minimizing obstructions. More specifically, the valve plate 347 extends from the tip 357 parallel to the exhaust conduit 242, and is disposed so that it bisects the flow stream through the exhaust conduit 242. As a result, exhaust gas is directed to the EGR conduit 342 and the tailpipe 282 with minimal pressure loss.

In the event the EGR control unit 500 determines that additional flow through LR-EGR system 300 is indicated such as to address increasing NOx levels, the valve plate 347 is moved beyond the fully open position of FIG. 5 to variable exhaust throttling positions such as that shown in FIG. 6. Throttling of flow into the tailpipe 282 is effected by the single valve plate 347, which is moved to close off at least a part of the flow into the tailpipe 282. Throttling the tailpipe 282 increases the pressure available to drive EGR gas flow through the LR-EGR system 300. Exhaust gas flow into the EGR conduit 342 is increased because of a larger mass flow rate intercepted by the new position of the valve plate 347. Accordingly, exemplary embodiments may provide operation of the LR-EGR system 300 over a broader range of operating conditions of the engine 102 then would otherwise be achieved. In addition, needs that may otherwise exist for valves in the intake duct 230 and near the inlet end 214 of the compressor 210 are avoided.

Example embodiments are provided so that this disclosure will be thorough, and will convey the scope to those who are skilled in the art. Details may be set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies may not be described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An exhaust gas recirculation (EGR) system for an internal combustion engine, comprising:
an exhaust conduit configured to receive exhaust gas from the internal combustion engine;
a junction coupled to the exhaust conduit for receiving the exhaust gas therefrom;
an EGR conduit connected with the junction and configured to recirculate a portion of the exhaust gas to an intake side of the internal combustion engine;
a tailpipe connected coupled to the junction and configured to discharge at least a portion of the exhaust gas to atmosphere; and
a control valve disposed at the junction and operably configured to control entry of the exhaust gas into the EGR conduit and to throttle entry of the exhaust gas into the tailpipe.

2. The exhaust gas recirculation system of claim 1, further comprising:
a compressor configured to charge combustion air supplied to the internal combustion engine, the compressor having an inlet end configured to receive the combustion air;
an intake duct connected with the compressor at the inlet end and configured to supply the combustion air to the compressor, wherein the EGR conduit is connected with the intake duct to supply EGR gas to the inlet end of the compressor.

3. The exhaust gas recirculation system of claim 2, wherein intake duct does not include a throttle valve.

4. The exhaust gas recirculation system of claim 1, wherein control valve comprises:
a promontory formed at the junction dividing the EGR conduit from the tailpipe and extending to a tip; and
a valve plate disposed to pivot about the tip.

5. The exhaust gas recirculation system of claim 4, wherein the promontory bisects the exhaust conduit.

6. The exhaust gas recirculation system of claim 4, wherein the valve plate comprises a terminal end positionable upstream of the tip in the exhaust conduit when the valve plate is in a closed position for closing the EGR conduit from the exhaust conduit.

7. The exhaust gas recirculation system of claim 1 further comprising:
a valve plate in the control valve; and
a position sensor associated with the control valve and configured to determine a position of the valve plate.

8. The exhaust gas recirculation system of claim 1 further comprising:
a compressor configured to charge combustion air supplied to the internal combustion engine, the compressor having an inlet end configured to receive the combustion air, wherein the EGR conduit is configured to supply EGR gas to the inlet end of the compressor;
an intake duct connected with the compressor and configured to supply the combustion air to the compressor;
an EGR cooler connected with the EGR conduit; and
a second EGR conduit extending from the EGR cooler to the intake duct, wherein the second EGR conduit and the intake duct do not include a throttle valve.

9. The exhaust gas recirculation system of claim 8, wherein the EGR conduit and the tailpipe extend away from the junction in opposite directions.

10. The exhaust gas recirculation system of claim 1, further comprising a turbine receiving the exhaust gas from the internal combustion engine, the junction located downstream of the turbine from the internal combustion engine.

11. An exhaust gas recirculation (EGR) system for an internal combustion engine, comprising:
an exhaust conduit configured to receive exhaust gas from the internal combustion engine;
an exhaust aftertreatment system disposed in the exhaust conduit;
a junction coupled to the exhaust conduit for receiving the exhaust gas therefrom and located downstream of at least a portion of the aftertreatment system from the internal combustion engine;
an EGR conduit connected with the junction and configured to recirculate a portion of the exhaust gas to an intake side of the internal combustion engine;
a tailpipe connected to the junction and configured to discharge at least a portion of the exhaust gas to atmosphere; and
a control valve disposed at the junction with a valve plate in the control valve configured to control entry of the exhaust gas into the EGR conduit and the valve plate configured to throttle entry of the exhaust gas into the tailpipe.
a control valve disposed at the junction and having a valve plate operably configured to control entry of the exhaust gas into the EGR conduit and to throttle entry of the exhaust gas into the tailpipe.

12. The exhaust gas recirculation system of claim 11, further comprising:
a compressor configured to charge combustion air supplied to the internal combustion engine, the compressor having an inlet end configured to receive the combustion air;
an intake duct connected with the compressor at the inlet end and configured to supply the combustion air to the compressor, wherein the EGR conduit is connected with the intake duct to supply EGR gas to the inlet end of the compressor.

13. The exhaust gas recirculation system of claim 12, wherein intake duct does not include a throttle valve.

14. The exhaust gas recirculation system of claim 11, wherein control valve comprises a promontory formed at the junction dividing the EGR conduit from the tailpipe and extending to a tip, wherein the valve plate disposed to pivot about the tip.

15. The exhaust gas recirculation system of claim 14, wherein the promontory bisects the exhaust conduit.

16. The exhaust gas recirculation system of claim 14, wherein the valve plate comprises a terminal end positionable upstream of the tip in the exhaust conduit when the valve plate is in a closed position for closing the EGR conduit from the exhaust conduit.

17. The exhaust gas recirculation system of claim 11 further comprising a position sensor associated with the control valve and configured to determine a position of the valve plate.

18. The exhaust gas recirculation system of claim 11 further comprising:
a compressor configured to charge combustion air supplied to the internal combustion engine, the compressor having an inlet end configured to receive the combustion air, wherein the EGR conduit is configured to supply EGR gas to the inlet end of the compressor;
an intake duct connected with the compressor and configured to supply the combustion air to the compressor;
an EGR cooler connected with the EGR conduit; and
a second EGR conduit extending from the EGR cooler to the intake duct, wherein the second EGR conduit and the intake duct do not include a throttle valve.

19. The exhaust gas recirculation system of claim 18, further comprising an exhaust manifold receiving the exhaust gas from the engine; an intake manifold configured to deliver the combustion air to the internal combustion engine; and an EGR conduit configured to channel exhaust gas from the exhaust manifold to the intake manifold.

20. An exhaust gas recirculation (EGR) system for an internal combustion engine, comprising:
a turbine configured to receive exhaust gas from the internal combustion engine;
a compressor connected with the turbine and configured to charge combustion air supplied to the internal combustion engine, the compressor having an inlet end configured to receive the combustion air;
an intake duct connected with the compressor and configured to supply the combustion air to the inlet end;
an exhaust conduit configured to receive the exhaust gas from the turbine;
a junction coupled to the exhaust conduit for receiving the exhaust gas therefrom;
an EGR conduit connected with the junction and configured to recirculate a portion of the exhaust gas to an intake side of the internal combustion engine through the compressor;
a tailpipe connected with the junction and configured to discharge at least a portion of the exhaust gas to atmosphere; and
a control valve disposed at the junction with a valve plate configured to control entry of the exhaust gas into the EGR conduit and the valve plate configured to throttle entry of the exhaust gas into the tailpipe.
a control valve disposed at the junction and having a valve plate operably configured to control entry of the exhaust gas into the EGR conduit and to throttle entry of the exhaust gas into the tailpipe.
